(19) United States
(12) Patent Application Publication
(10) Pub. No.: US 2005/0149956 A1
(43) Pub. Date: Jul. 7, 2005

(54) Disk device including alarm indicating portion

(75) Inventors: Takeshi Makino, Takefu-city (JP); Masahiko Nishide, Takefu-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Takefu-city (JP)

(21) Appl. No.: 11/028,583

(22) Filed: Jan. 5, 2005

(30) Foreign Application Priority Data
Jan. 7, 2004 (JP) 2004-001981

(51) Int. Cl. G11B 17/03; G11B 17/04; G11B 33/02

(52) U.S. Cl. 720/601

(57) ABSTRACT

The present invention provides a disk device including an alarm indicating portion that forms a high-visibility indicating portion in the disk device, which give a warning about directly viewing a laser beam of the disk device when the disk device is disassembled. A high-visibility protruding indicating portion 17 is formed near a pickup lens 14A and in a rear side of a tray 11 in a disk device 10 in which the pickup lens 14A irradiates a laser beam to a recording surface of a disk placed on the tray 11 carried into/out of the disk device 10 to perform recording/reading, thereby preventing the irradiated laser beam from being viewed.

The present application is based on and claims priority of Japanese patent applications No. 2004-001981 filed on Jan. 7, 2004, the entire contents of which are hereby incorporated by reference.

### BACKGROUND OF THE INVENTION

1. Field of the Invention

The present invention relates to a disk device, and more particularly, to a disk device provided in an electronic apparatus or the like, including an alarm indicating portion that gives a warning an alarm about directly viewing a laser beam near a pickup lens when disassembling the disk device.

2. Description of the Related Art

A conventional disk device provided in an electronic apparatus or the like includes a tray capable of carrying in/out a disk by opening and closing the disk device, wherein a laser beam is irradiated to a recording surface of a disk that is a recording medium carried into the disk device by the tray to perform recording/reading of the disk.

In such a conventional disk device, a label for giving caution is attached to a side surface of the disk device in order to prevent eyes from being exposed to the laser beam.

Japanese Patent Laid-Open Publication No. 2002-133824 (Patent Reference 1) discloses a disk cartridge used in a recording and/or reading device such as a disk autochanger in which a tray on which a disk is placed includes an address indicating portion of the tray. Japanese Utility Model Laid-Open Publication No. 3092871 (Patent Reference 2) discloses a disk device with a label attached which reduces manufacturing costs of a frame of the disk device.

However, when a repairman disassembles the disk device for maintenance with the laser beam being irradiated, the repairman may directly view the laser beam. Further, if the laser beam is irradiated to the eyes, retina may be damaged, causing visual field aftereffect.

Furthermore, when a label is attached to a disk device for caution as described above, a label is required, which increases costs and requires a lot of work for labeling. Moreover, labeling requires unnecessary work and effort when relabeling the misplaced label, which impedes the efficiency of the manufacturing process.

In addition, attaching a label on a tray that carries into/out of a disk device may cause a failure such that if the label is removed during use, the label may attach to some other components or the disk and prevent the disk from being carried in/out.

### SUMMARY OF THE INVENTION

The invention is achieved in view of the above described problems, and aims at providing a disk device including an alarm indicating portion that forms a high-visibility indicating portion in the disk device, which can effectively give a warning about a laser beam of the disk device when the disk device is disassembled, and has good workability, increasing the manufacturing efficiency.

A disk device including an alarm indicating portion according to the first aspect of the invention includes a tray that carries a disk into/out of the disk device, a turn table that rotates the disk, a damper that holds the disk while the disk is rotated, and a pickup lens that irradiates a laser beam to a recording surface of the disk to perform recording/reading of the disk, wherein an alarm indicating portion such a letter or graphic for giving caution not to directly view an optical system is provided integrally in a protruding manner integrally to a component of the disk device placed near the pickup lens.

According to this arrangement, the high-visibility protruding indicating portion is formed near the pickup lens that irradiates the laser beam, thereby giving caution against viewing the laser beam irradiated from the pickup lens.

A disk device including an alarm indicating portion according to the second aspect of the invention is the disk device including an alarm indicating portion according to the first aspect of the invention, wherein the component includes the tray, and the indicating portion is formed on a top surface of the tray.

According to this arrangement, the indicating portion formed on the tray near the pickup lens allows giving caution against viewing the laser beam irradiated from the pickup lens.

A disk device including an alarm indicating portion according to the third aspect of the invention is the disk device including an alarm indicating portion according to the first aspect of the invention, wherein the component includes a support member that supports the clamper, with the indicating portion formed on a top surface of the support member.

According to this arrangement, the indicating portion formed on the support member near the pickup lens allows giving caution against viewing the laser beam irradiated from the pickup lens.

A disk device including an alarm indicating portion according to the fourth aspect of the invention is the disk device including an alarm indicating portion according to the first aspect of the invention, wherein the component includes the tray and the support member that supports the clamper, with the indicating portion formed on a top surface of each of the tray and the support member, and placed substantially on a diagonal line with the pickup lens therebetween.

According to this arrangement, the indicating portions that give caution against viewing the laser beam irradiated from the pickup lens are placed substantially on the diagonal line with the pickup lens therebetween, thereby giving a warning about the laser beam irradiated from the pickup lens more effectively.

A disk device including an alarm indicating portion according to the fifth aspect of the invention is the disk device including an alarm indicating portion according to the third or fourth aspect of the invention, wherein a flat plate portion is formed on the top surface of the support member, a stepped recess is formed in the flat plate portion, and the indicating portion is formed in a protruding manner on a bottom surface of the stepped recess so as not to exceed a depth of the stepped recess.

According to this arrangement, a height of the indicating portion formed on the bottom surface of the stepped recess is lower than the depth of the stepped recess, thereby allowing to prevent the interference such that the indicating portion get caught with the other components or devices during assembly, and also provides the high-visibility indicating portion to be formed.

A disk device including an alarm indicating portion according to the sixth aspect of the invention is the disk device including an alarm indicating portion according to the fifth aspect of the invention, wherein the depth of the stepped recess is 2 mm, and the height of the indicating portion is 1 mm or less.

According to this arrangement, the indicating portion is formed to be locally thick, thereby increasing the strength of the indicating portion and preventing interference between the indicating portion and the other components.

The disk device including an alarm indicating portion according to the first aspect of the invention includes the tray that carries the disk into/out of the disk device, the turn table that rotates the disk, the damper that holds the disk while the disk is rotated, and the pickup lens that irradiates the laser beam to the recording surface of the disk to perform recording/reading of the disk, wherein the alarm indicating portion such as the letter or the graphic for giving caution is provided integrally in the protruding manner integrally to the component of the disk device placed near the pickup lens. This provides the disk device including an alarm indicating portion capable of forming an alarm indicator about viewing the laser beam near the pickup lens that irradiates the laser, which effectively provides an alarm to prevent an accident caused by viewing the laser beam.

The disk device including an alarm indicating portion according to the second aspect of the invention is the disk device including an alarm indicating portion according to the first aspect of the invention, wherein the component includes the tray, and the indicating portion is formed on the top surface of the tray. This provides the disk device including an alarm indicating portion that can form an alarm indicator about viewing the laser beam on the tray placed near the pickup lens, which effectively provides an alarm to prevent an accident caused by viewing the laser beam.

The disk device including an alarm indicating portion according to the third aspect of the invention is the disk device including an alarm indicating portion according to the first aspect of the invention, wherein the component includes the support member that supports the clamper, with the indicating portion formed on the top surface of the support member. This provides the disk device including an alarm indicating portion that can form an alarm indicator about viewing the laser beam on the support member that supports the damper placed near the pickup lens, which effectively provides an alarm to prevent an accident caused by viewing the laser beam.

The disk device including an alarm indicating portion according to the fourth aspect of the invention is the disk device including an alarm indicating portion according to the first aspect of the invention, wherein the component includes the tray and the support member that supports the clamper, with the indicating portion formed on the top surface of each of the tray and the support member, and placed substantially on the diagonal line with the pickup lens therebetween. This provides the disk device including an alarm indicating portion that can effectively provides an alarm by the indicating portions placed substantially on the diagonal line with the pickup lens therebetween.

The disk device including an alarm indicating portion according to the fifth aspect of the invention is the disk device including an alarm indicating portion according to the third or fourth aspect of the invention, wherein the flat plate portion is formed on the top surface of the support member, the stepped recess is formed in the flat plate portion, and the indicating portion is formed in the protruding manner on the bottom surface of the stepped recess so as not to exceed the depth of the stepped recess. This provides the disk device including an alarm indicating portion that prevents the interference between the indicating portion and the other components or devices, and also provides the high-visibility indicating portion to be formed.

The disk device including an alarm indicating portion according to the sixth aspect of the invention is the disk device including an alarm indicating portion according to the fifth aspect of the invention, wherein the depth of the stepped recess is 2 mm, and the height of the indicating portion is 1 mm or less. This increases the local strength near the indicating portion.

### BRIEF DESCRIPTION OF THE DRAWINGS

FIG. 1 is a perspective view of electronic apparatus including a disk device according to the present invention;

FIG. 2 is a plan view of the disk device with a tray being opened according to the present invention;

FIG. 3 is a plan view of the disk device with the tray being closed according to the present invention;

FIG. 4 is an enlarged perspective view of essential portions of the disk device according to the present invention;

FIG. 5 is an enlarged plan view of essential portions of a tray according to the present invention;

FIG. 6 is a sectional view of a support member according to the present invention;

FIG. 7 is a plan view of the tray according to the present invention;

FIG. 8 is an enlarged plan view of essential portions of a tray according to another embodiment; and

FIG. 9 is a plan view of a disk device with the tray being closed.

### DETAILED DESCRIPTION OF THE PREFERRED EMBODIMENTS

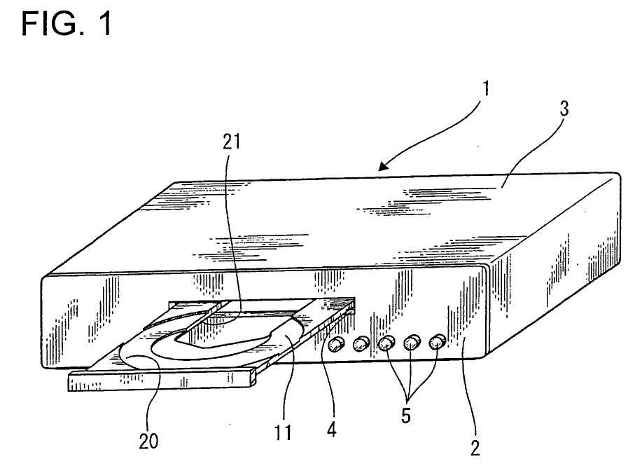

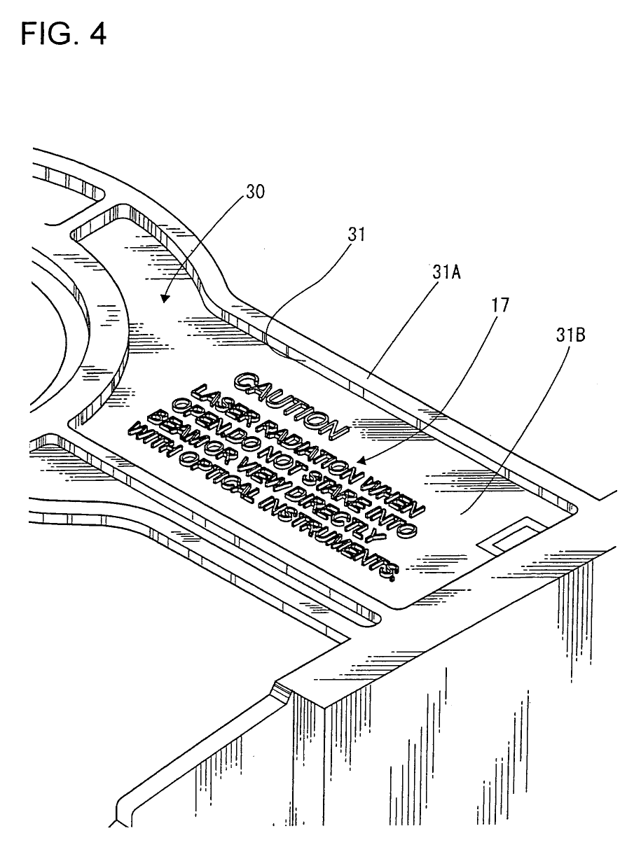

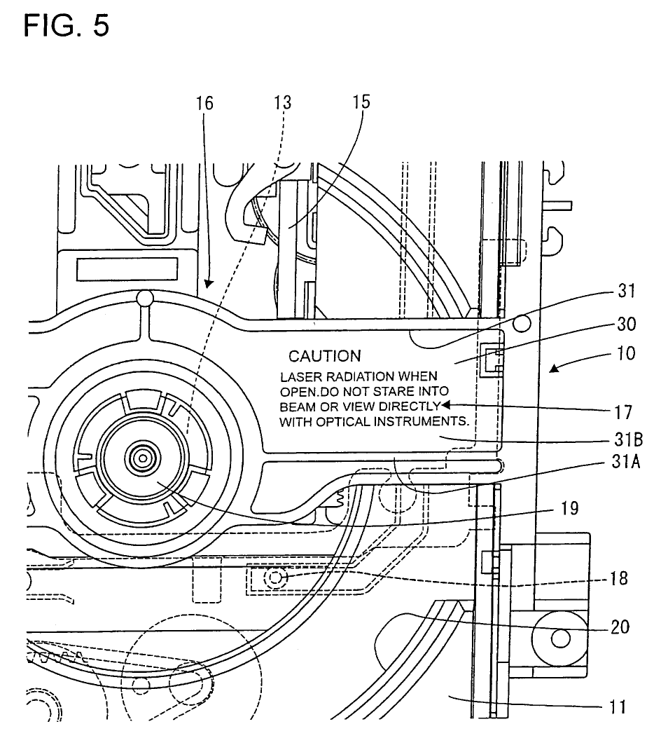

Now, preferred embodiments of the invention will be described with reference to FIGS. 1 through 9. The invention, of course, may be easily applied to arrangements other than those described in the embodiments within the scopes of the present invention.

FIG. 1 is a perspective view of an example of an electronic apparatus including a disk device. Electronic apparatus 1 is entirely formed in a box shape by a flat front panel 2 and a cabinet 3. The front panel 2 disposed at the front of the electronic apparatus 1 is removable from the cabinet 3, and a panel opening 4 is formed in substantially a center of the front panel 2.

A plurality of operation buttons 5 are provided on appropriate positions of the front panel 2, which are operated to open and close a tray described below or to perform recording or reading. These operation buttons 5 may have various functions other than the functions described above. In FIG. 1, an alarm indicating portion such as a letter or graphic for giving caution not to directly view an optical system provided integrally in a protruding manner to a component of the disk device according to the invention is placed in a position that cannot be seen by a user.

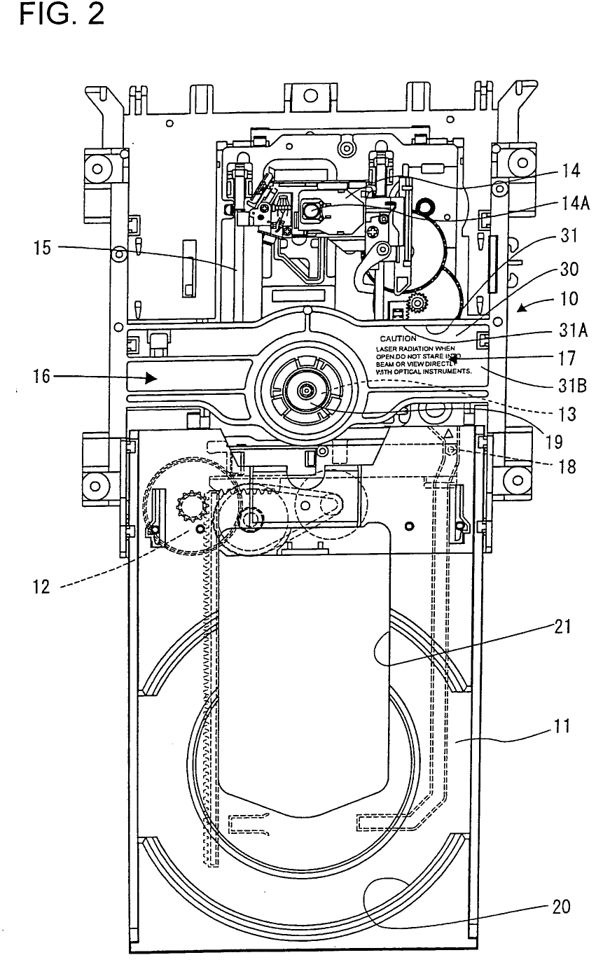

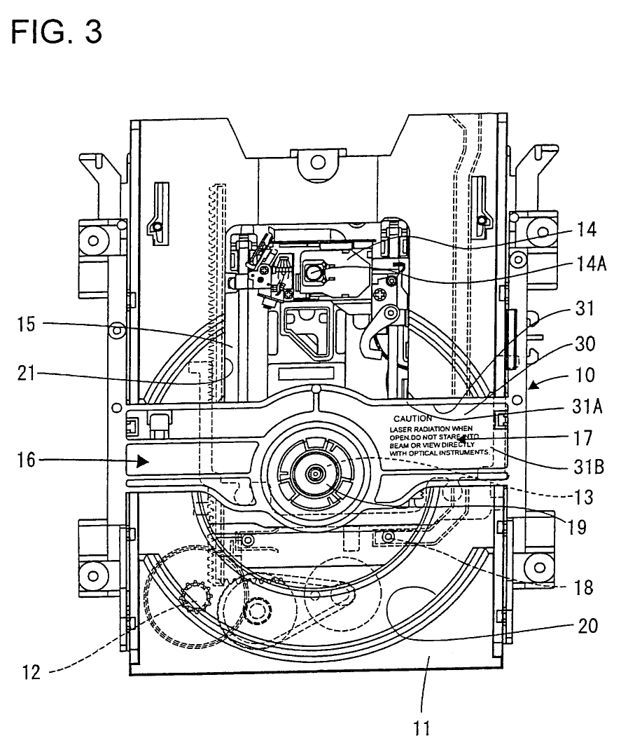

FIG. 2 is a plan view of the disk device according to the invention with the tray being opened, and FIG. 3 is a plan view of the disk device with the tray being closed.

The disk device 10 includes a tray 11 on which a disk is placed, a drive unit 12 that carries in/out the tray 11 frontward and rearward to open and close the tray 11, a turn table 13 that lifts up from below and rotates the disk placed on the tray 11, a damper 19 that holds the disk while the disk is rotated, a pickup unit 14 having a pickup lens 14A that performs recording/reading of video or audio signals recorded on the disk, and a moving unit 15 that moves the pickup unit 14 in the radial direction of the disk frontward and rearward of the disk device 10. The recording/reading of the disk device in the embodiment may have functions of both recording and reading or a function of either recording or reading, and the disk device is not limited to one having both functions.

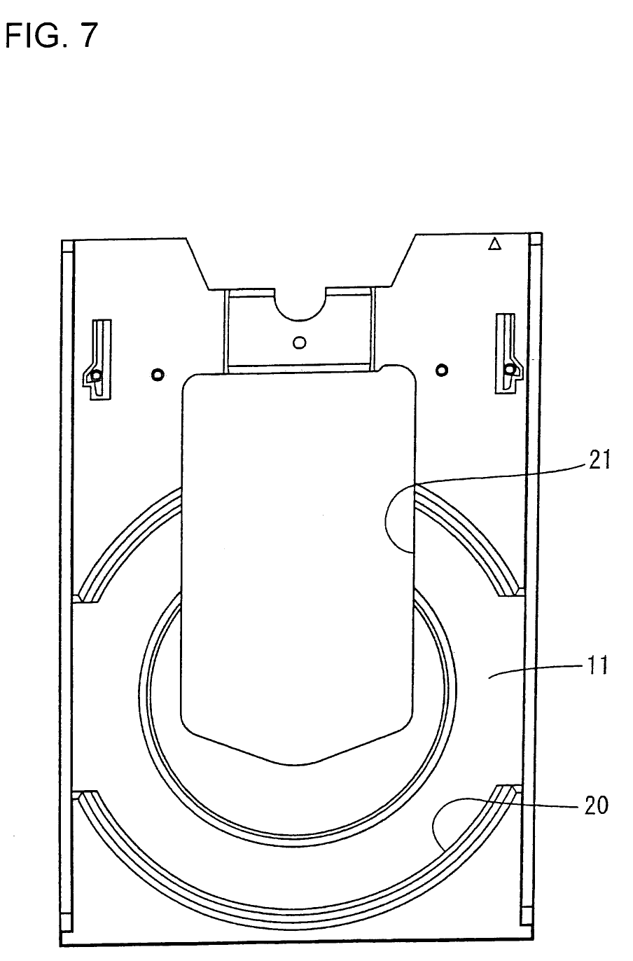

Next, the tray 11 will be described in detail. FIG. 7 is a plan view of the tray, and as shown in FIG. 7, the tray 11 is entirely formed substantially into a rectangle, and a circular groove 20 is formed corresponding to a circle of the disk placed on the tray 11 on a frontward side (a lower side in FIG. 7) of the top surface of the tray 11. A substantially rectangular opening 21 is formed in a substantial center of the tray 11, and with the disk being placed on the tray 11, a laser beam is irradiated from the pickup lens 14A by operating the operation button 5 to perform recording or reading of the disk.

A support member 16 formed integrally with the disk device 10 is provided in an upper portion of the disk device 10, and supports the clamper 19 provided in an upper portion of the turn table 13.

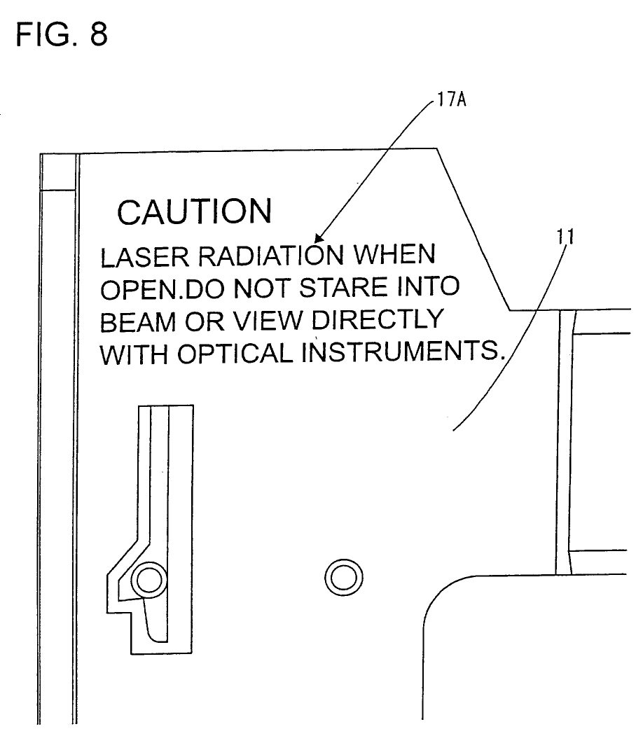

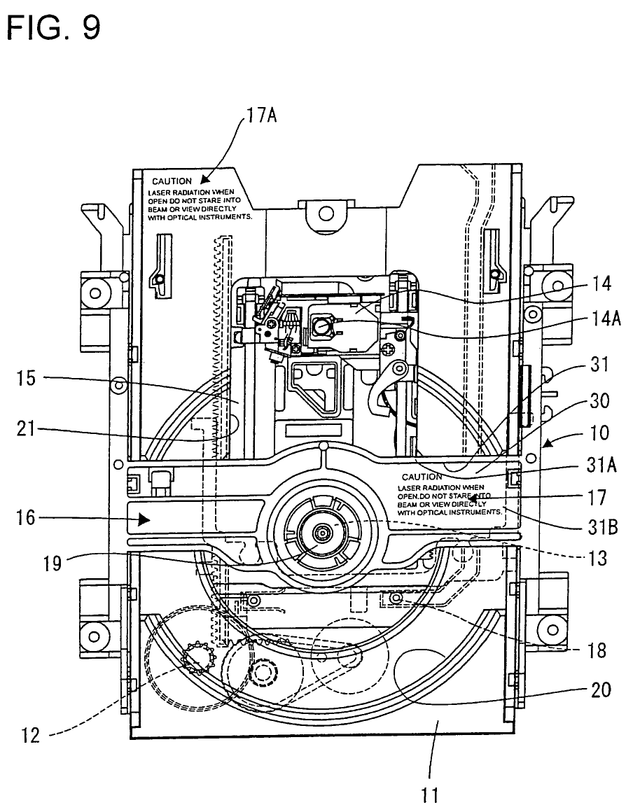

As described above, the opening 21 is formed in substantially the center of the tray 11, and near the opening 21, a high-visibility three-dimensional indicating portion 17 indicating “Do not view a laser beam of a pickup lens” is formed in an upward protruding manner. In the present embodiment, the indicating portion 17 is formed in the support member 16 provided in the upper portion of the disk device 10, but various modifications may be made not limited to this arrangement. For example, an indicating portion 17A that gives a warning about directly viewing a laser beam may be formed in a rear side of the tray and near the pickup lens 14A as shown in another embodiment in FIG. 8 (for the simplicity of the figure, the indicating portion is not shown in an protruding manner). Alternatively, indicating portions 17 and 17A may be formed in the support member 16 and the tray 11, respectively and placed substantially on a diagonal line with the pickup lens 14A therebetween as shown in an embodiment in FIG. 9.

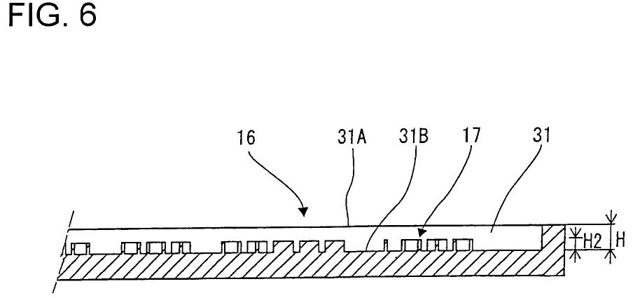

The indicating portion 17 formed in the support member 16 is placednear the pickup lens 14A as described above, wherein a top surface of the support member 16 is formed in a flat plate portion 30, and more specifically, the flat plate portion 30 has a stepped recess 31 formed therein, and the indicating portion 17 is formed in a one-step upward protruding manner from a bottom surface 31B of the stepped recess 31 formed one step lower than a top surface 31A of the stepped recess 31. As shown in FIG. 6, a depth H of the stepped recess 31 in which the indicating portion 17 is formed is 2 mm. In this case, a height H2 of the protruding indicating portion in the depth direction is preferably 1 mm or less, more preferably 0.3 mm to 0.7 mm, and more specifically, 0.5 mm. This prevents the indicating portion 17 from protruding from the top surface 31A of the stepped recess, thereby preventing the protruding indicating portion 17 from coming into contact with various components or devices provided in the disk device 10 in opening and closing operations when carrying in/out the tray 11.

In another embodiment in FIG. 8, the protruding indicating portion 17A is formed on the tray 11 near the pickup lens 14A, thereby preventing the irradiated laser beam from being viewed. Further, in the embodiment in FIG. 9, the indicating portions 17 and 17A formed on the support member 16 and the tray 11, respectively, are placed substantially on the diagonal line with the pickup lens 14A therebetween, thereby allowing an effective warning to an operator by increasing the number of the indicating portions 17 and 17A to improve an alarm function.

Reference number 18 denotes an excessive insertion preventing boss of the tray 11, and the excessive insertion preventing boss 18 is formed below the tray 11 and move the tray 11 to an appropriate position to stop the carrying in of the tray 11.

According to the above described arrangement, in the case where the pickup lens 14A of the pickup unit 14 irradiates the laser beam upward with no disk being placed on the tray 11, the high-visibility three-dimensional indicating portion 17 is formed in the protruding manner in a visible position near the pickup lens 14A, and thus an operator who disassembles the disk device 10 can easily view the indicating portion 17 before the laser beam is irradiated to eyes or viewing the laser beam, thereby effectively preventing an adverse effect on human bodies such as directly viewing the laser beam.

Moreover, because the indicating portions 17 and 17A are formed integrally with the support member 16 and the tray 11 of the disk device 10 for giving caution, and there is no need for labeling a separate caution label or the like, a labeling process can be omitted, providing good workability and increasing manufacturing efficiency.

Furthermore, in case supplement is required to manufacture an indicating portion 17 to a tray 11 of a disk device 10 manufactured in volume, because letters of the indicating portion 17 may be formed in a protruding manner rather than a recessed manner, wording may be easily added by cutting part of a mold corresponding to shapes of the letters of the indicating portion 17, thereby providing versatility.

1. A disk device including an alarm indicating portion, comprising:
a tray that carries a disk into/out of the disk device;
a turn table that rotates the disk;
a damper that holds the disk while the disk is rotated; and
a pickup lens that irradiates a laser beam to a recording surface of the disk to perform recording/reading of the disk,
wherein an alarm indicating portion such as a letter or graphic for giving caution not to directly view an optical system is provided integrally in a protruding manner to a component of the disk device placed near the pickup lens.

2. The disk device including an alarm indicating portion according to claim 1, wherein the component includes the tray, and the indicating portion is formed on a top surface of the tray.

3. The disk device including an alarm indicating portion according to claim 1, wherein the component includes a support member that supports the clamper, with the indicating portion formed on a top surface of the support member.

4. The disk device including an alarm indicating portion according to claim 1, wherein the component includes the tray and the support member that supports the clamper, with the indicating portions formed on a top surface of each of the tray and the support member, which are placed substantially on a diagonal line with the pickup lens therebetween.

5. The disk device including an alarm indicating portion according to claim 3 or 4, wherein a flat plate portion is formed on the top surface of the support member, a stepped recess is formed in the flat plate portion, and the indicating portion is formed in a protruding manner on a bottom surface of the stepped recess so as not to exceed a depth of the stepped recess.

6. The disk device including an alarm indicating portion according to claim 5, wherein the depth of the stepped recess is 2 mm, and a height of the indicating portion is 1 mm or less.
